(19) United States
(12) Patent Application Publication
(10) Pub. No.: US 2015/0304430 A1
(43) Pub. Date: Oct. 22, 2015

(54) Methods and Systems for Transmitting Mobile Device Information

(71) Applicants: KONINKLIJKE KPN N.V., The Hague (NL); NEDERLANDSE ORGANISATIE VOOR TOEGEPAST- NATUURWETENSCHAPPELIJK ONDERZOEK TNO, 's-Gravenhage (NL)

(72) Inventors: Bryan Jerrel Busropan, The Hague (NL); Nicolaas Keesmaat, Voorburg (NL)

(73) Assignees: Koninklijke KPN N.V., The Hague (NL); Nederlandse Organisatie voor Toegepast- Natuurwetenschappelijk Onderzoek TNO, 's Gravenhage (NL)

(21) Appl. No.: 14/443,462

(22) PCT Filed: Nov. 18, 2013
(86) PCT No.: PCT/EP2013/074031

§ 371 Date: May 18, 2015

(30) Foreign Application Priority Data
Nov. 19, 2012 (EP) 12193181.0

(51) Int. Cl. H04L 29/08; H04W 8/18

(52) U.S. Cl. CPC H04L 67/141; H04W 8/18; H04L 67/10

(57) ABSTRACT

Method and systems for providing user data from a communication module (using a first telecommunications network) to data processing center (of a second telecommunications network) is disclosed. The user data is provided in a data field of a session setup message. The user data in the data field of the session setup message is adapted or guaranteed (e.g., required by a telecommunications standard) to be forwarded from the first telecommunications network to the second telecommunication network.

### FIELD OF INVENTION

The disclosure generally relates to the field of data transfer over telecommunication network(s). In particular, though not necessarily, the disclosure relates to methods, systems, telecommunications networks, support nodes, domain name system servers, monitors, communication modules, and computer program products for transferring user data in a machine-to-machine communications setting.

### BACKGROUND

In machine-to-machine (M2M) communications, hundreds or thousands (or more) communication modules are distributed, e.g., in a large area, and each module is transmitting user data from time to time to a data collection entity. An example involves the electronic reading of, e.g., electricity meters at the homes of customers located all over a country. Other examples include sensors, meters, appliances, electronic devices/systems, which may be equipped with communication modules that allow for reporting of user data such as status information and/or location information to a data processing center over telecommunications network(s). The user data collected may be stored and subsequently processed and/or analyzed depending on the particular machine-to-machine application.

M2M communications typically have relatively little or a limited amount of data to transport. Accordingly, a method of transferring user data from a communication module to a data processing centre over a telecommunications network is proposed in WO 2010/049437, wherein a telecommunications network wirelessly receives a signaling message from a communication module, and the user data is contained of a signaling message.

### SUMMARY

In practice, many of the communication modules in a M2M communications setting are located in telecommunication networks that are not on the same network to which the data processing center is communicably connected. In the system disclosed in lines 8-15 on page 3 of WO 2010/049437, the signaling message carries user data in an information element of a network attach request message that is either a new information element or an existing information element that is not used in a particular situation (i.e., unused data fields which are not configured to be always transmitted between telecommunication networks). When the signaling message is transmitted from a communication module in a visiting/roaming network to the home network, the user data inserted in such an information element is sometimes filtered out by the visiting network, e.g., because the visiting network is not required by the telecommunications standard to forward the user data in the signaling message. As a result, the user data does not reach the data processing center, and/or there is no guarantee that the user data would not be filtered out by the visiting network to the home network.

Some options are available to ensure the receipt of the user data. For instance, the communication module may transmit a Short Message Service (SMS) message from the visiting network to the home network to which the data processing center is located. However, this solution is costly because each SMS transmitted generates a Call Data Record (CDR) at the visiting network and at the home network. If SMS messages are transmitted frequently and/or many communications modules are transmitting SMS messages, the costs become significant. In another instance, the communication module may setup a data session to the data processing center, and transmits the user data over the data session as payload. The same problem relating to costs is also present here, because transmitting the user data over a data session would also create a CDR. Furthermore, this solution is not ideal because it requires the telecommunications network to inspect the payload of the packets transmitted over a data network, which may intrude on the privacy of the communication module.

To alleviate the problems discussed herein, improved methods and systems for transmitting user data to a data processing center are disclosed. In particular, a data field of a session setup message is used to transmit user data from a first telecommunications network (i.e., a visited network) to a second telecommunications network (i.e., a home network) in which a data processing center for processing the user data is located. The data field is characterized by the requirement for the first telecommunications network to forward the content in the data field to the second telecommunications network for processing. A communication module provides the user data in the data field, either as by itself or piggybacked with other data, and transmit the user data as part of a session setup message to a first telecommunications network. Such a requirement ensures that the user data in the data field is always passed on to the second telecommunications network.

According to one aspect, a method for transmitting user data from a communication module communicably connected to a first telecommunications network to a second telecommunications network is disclosed. Said method is preferably performed by a visited network (i.e., the first telecommunications network). The user data is provided to a data processing center in the second telecommunications network. The method comprises receiving the user data in a data field of a session setup message transmitted from the communication module and transmitting the user data from the first network to the second network, wherein the user data in the data field of the session setup message is adapted to be forwarded from the first telecommunications network to the second telecommunications network.

Another method for processing user data from a communication module is also disclosed. Said user data is transmitted from the communication module communicably connected to a first telecommunications network to a second telecommunications network. Said method is preferably performed by the home network (i.e., the second telecommunications network). This method comprises receiving the user data from a data field of a session setup message, said session setup message being transmitted from the communication module to the first telecommunications network. The user data in the data field of in the session setup message is adapted to be forwarded from the first telecommunications network to the second telecommunications network.

Yet another method for transmitting user data from a communication module communicably connected to a first telecommunications network to a second telecommunications network is disclosed. Said method is preferably performed by the communication module, e.g., by a computer software product configured to execute on a processor of the communication module. Said user data is provided to a data processing center in the second telecommunications network. This method comprises providing the user data in a data field of a session setup message. Said session setup message having the user data from the communication module is transmitted to the first network. The user data in the data field of in the session setup message is adapted to be forwarded from the first telecommunications network to the second telecommunications network.

In these three methods, the user data in the data field is advantageously provided to the second telecommunications network without fail. The user data in the data field may be forwarded to the second telecommunications network without being modified, filtered, and/or removed. The forwarding of the user data in the data field may be required by the standard processing of the session setup message, e.g., due to the nature of the data field of the session setup message, and/or due to the requirements of a telecommunications standard.

The data field is preferably a data field that is in use. In some embodiments, the data in the data field may be easily modified by the communication module to include user data. The user data may be used in place of other data normally used for the data field. In some cases, the user data may be appended to the other data normally used for the data field (piggybacking). In either situation, the user data in the data field is forwarded to the second telecommunications network for processing.

According to one aspect, wherein the first telecommunications network is operated by a visited operator and the second telecommunications network is operated by a home operator. In the system described in WO2010/049437, there exists a problem of the visited network filtering out the user data before it reaches the home network. The methods and systems disclosed herein alleviate such a problem for a roaming communications module because the user data in the data field is adapted (required) to be forwarded by the visited operator to the home operator.

According to one aspect, the session setup message is a Packet Data Protocol (PDP) context setup message. The use of a session setup message, e.g., the PDP context setup message enables the user data to be carried in a setup message rather than in a payload of a data session or in a Short Message Service (SMS) message, provides added privacy. The user of a setup message requires the home network to only inspect the contents of the data fields in the setup message, rather than requiring the home network to inspect the payloads of a data session or SMS messages. Using a session setup message provides an added benefit to avoid generating a Call Detail Record by transmitting the user data in the session setup message and causing the setup message to fail due to the user data being invalid data for the data field.

In order to setup a session, the communication module may provide an access point name, which identifies the access point to which the communication module wishes to connect. However, because the access point name does not provide an address of the supporting node which provides the access point, the content in the access point name field must be forwarded to the second (home) network for processing. Furthermore, the access point name can be advantageously easily modified by the communication module to insert the user data. According to one aspect, the data field is an access point name field, and the user data is appended to or replaces a valid access point name. The user data may be appended to other data (i.e., a valid access point name) according to a particular syntax. If valid access point name is also transmitted with the user data, then it is possible to still setup a session. As a result, the session setup message not only sets up the session, but also provides the user data in the setup.

According to one aspect, the user data is extracted in a processing part of the second telecommunications network, and said processing part is configured to receive requests associated with the data field. The processing part may be adapted to provide the extracted user data to the data processing center. In some embodiments, the processing part of the second telecommunications network is a domain name system server configured to resolve an access point name to an address of an access point to the Internet or an intranet. Advantageously, the processing part is configured to capture the user data in the second telecommunication network. The processing part is preferably adapted from a domain name server to detect, extract, and/or transmit the user data provided through the data field.

According to one aspect, the processing part is configured to receive a request associated with the data field. The request comprises content provided in the data field of the session setup message which was transmitted by the communication module. The request is preferably transmitted by the first telecommunications network as part of the processing of the session setup message. The request may be a resolve request, which is adapted to be received and/or processed by the processing part.

The processing part preferably stores associations of valid access point names to address(es) of the access points. Using these associations and/or a method to detect a particular syntax, the processing part then determines whether the request includes an invalid access point name (i.e., user data is appended to a valid access point name or other data, or the user data is provided as the sole content of the data field). Generally, said invalid access point name is used herein as referring to data which is not one of the valid access point name(s) which resolves to an address of an access point to the Internet or an Intranet.

Broadly speaking, if the access point name data field is not used, and another data field is used, the processor part may be adapted to determine if the request includes invalid data which does not allow the correct/successful processing of the request. The invalid data advantageously provides a way for the processing part to determine that the request includes user data, and in some cases provides a way to not create a Call Data Record because the session is not setup.

According to one aspect, when the request includes an invalid access point name, the invalid access point name is extracted from the request, and the invalid access point name provided to the data processing center. In some cases, the invalid access point name is directly forwarded to the data processing center and it is the data processing center which extracts the user data from the invalid access point name.

According to one aspect, a session reject message from the second telecommunications network to the first telecommunications network is transmitted. Such a message said message rejecting a session to be setup, e.g., if an invalid access point name is detected and/or the content of the data field cannot be processed correctly by the processing part in the second telecommunications network. Advantageously, no Call Detail Record (CDR) may be generated, or if one had been generated, it is removed. The transfer of user data as an invalid access point name thus incurs no (or little) cost.

According to one aspect, the user data comprises status information and/or location information. The user data is typically data which is transmitted in a machine-to-machine (M2M) setting. The methods and systems disclosed herein provides a method which enables a large number of communications modules, even if they are roaming, to have a sure way of transmitting the user data to the data processing center, while avoiding costs.

A telecommunications network, a support node, a DNS server, a monitor, and/or a communication module configured for performing the methods disclosed herein are described in the present disclosure.

The disclosure may also relate to a computer program product, implemented on computer-readable non-transitory storage medium, wherein the computer program product may comprise software code portions configured for, when run a computer, executing the method steps according to any of the methods described in the present disclosure. The computer program product is preferably implemented at least in part in any of: telecommunications networks, support nodes, domain name system servers, monitors, communication modules, and computer program products.

The disclosure will further be illustrated with reference to the attached drawings, which schematically show embodiments according to the disclosure. It will be understood that the disclosure is not in any way restricted to these specific embodiments. Hereinafter, embodiments of the invention aiming to alleviate the problem(s) described above will be described in further detail. Moreover, combinations of any of the embodiments and limitations are envisioned by the disclosure.

### BRIEF DESCRIPTION OF THE DRAWINGS

Aspects of the invention will be explained in greater detail by reference to exemplary embodiments shown in the drawings, in which:

FIG. 1 shows an exemplary schematic of a telecommunication system, according to an embodiment of the disclosure;

FIG. 2 shows an exemplary messaging diagram, according to an embodiment of the disclosure; and

FIG. 3 shows another exemplary messaging diagram, according to an embodiment of the disclosure.

### DETAILED DESCRIPTION

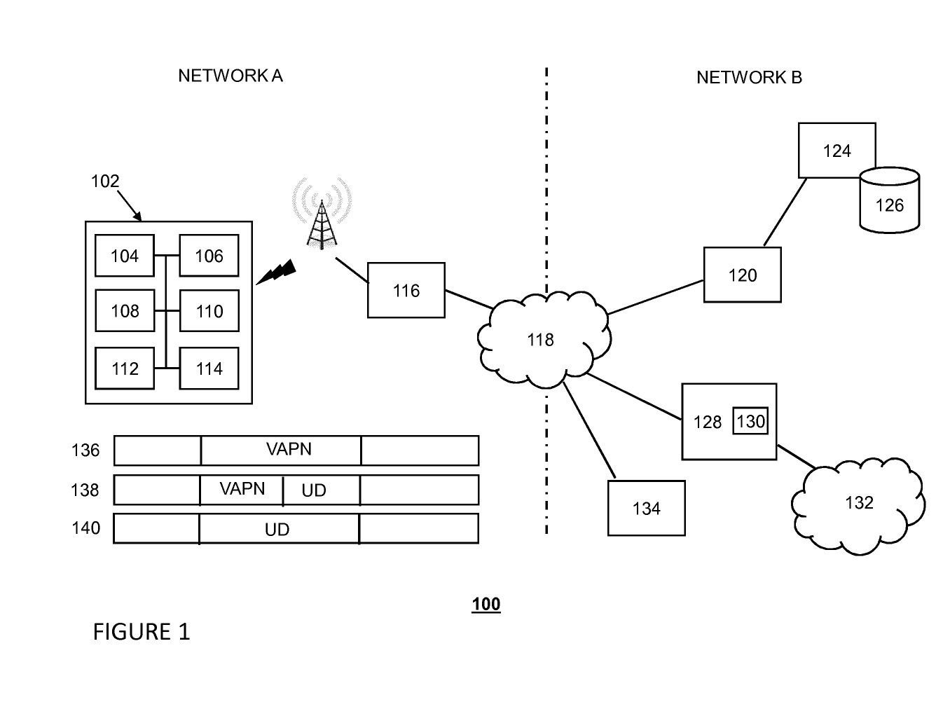

FIG. 1 shows an exemplary schematic of a telecommunication system, according to an embodiment of the disclosure. The telecommunication system makes use of a session setup message to provide user data from a communication module to a data processing center. In particular, user data is provided in a data field of the session setup message. In the context of this disclosure, the data field of the session setup message being used to transport user data is a used data field, and not an unused data field (i.e., a new information element or an existing information element that is not used in a particular situation).

The content in that data field is adapted to be forwarded to a processing part of a telecommunications network for processing. For instance, the data field is required as part of a telecommunications standard and/or normal operating procedures to always forward the contents (i.e., data which includes the user data) in the data field to the processing part of the telecommunications network. Due to this characteristic of the data field, there is a substantially increased chance that the user data provided in the data field is passed on to the processing part of a telecommunications network (even when the communication module is roaming in a different telecommunications network). In particular, the characteristic ensures that the user data is forwarded (rather than discarded, modified, and/or filtered out) by a visited (or roaming) telecommunications network when the user data is being transmitted to the processing part of the home telecommunications network.

Generally, the communication module is subscribed to a particular operator. The particular operator operates the home network but not the visited network. The differentiation between home network and visited network may be technically given by the type of subscriber entry in a specific network. If a subscriber has no entry in the home subscriber register of the network (e.g. Home Location Register (HLR) in GSM networks or local customer database in WLANs), the required subscriber data must first be requested by the visited network, e.g., from the subscriber's home network in order that the subscriber can be authenticated and any authorization for using the network services can be checked. The “visiting” subscriber acquires an entry in a user database of the visited network (e.g., Visited Location Register (VLR)) and the authorized network services are enabled. For the roaming procedure in practice, the subscriber data enables authentication, authorization and billing of the subscriber to be performed in the corresponding network. Thus, the term roaming is not linked to a specific network standard, but rather to the type of subscriber entry in the home subscriber register of the mobile radio network. In this context, the home network processes requests from the communication module such as session setup requests. However, certain data fields in requests from the communication module are adapted to be processed by the home network. In that situation, the visited network would forward the content in those data field(s) to the home network for processing.

The exemplary telecommunications system 100 comprises at least one communication module 102 (for simplicity only one is shown). The communication module may be configured for machine-to-machine (M2M) communications, e.g., sending a small amount of user data 10 times a day, wherein the user data is destined for a data processing center 124. The communication module may include a transmitter 110 and (an optional) receiver 114 for transmitting and (optionally) receiving messages, respectively.

The communication modules may collect user data, e.g., using a sensor 104 or other suitable device(s) to monitor/determine a state or a status of the communication module or the system in which the communication module is provided and/or installed. The sensor may be part of or in communication with the communication module. For instance, the communication module may be at least part of an electricity meter configured to provide meter readings periodically to a utilities company. In another instance, the communication module may be at least part of a vehicle configured to provide location information and/or status information to a fleet operator.

The communication module may be mobile or stationary. In some embodiments, the communication module is roaming in telecommunications network that is operated by a different operator from the operator of the telecommunications network on which the data processing center is communicably connected.

The sensor may typically monitor the operation a device and/or receive data from the device, and the sensor provides collected/measured user data (or a derivation thereof) to a processor 108. In some embodiments, raw data from the sensor may be processed to produce a derived raw data to be used as the user data. The user data may be stored in storage 112. The user data may include at least one of: timestamp, identifying information of the communication module, status information, state information, location information, etc. Examples of user data include cell identifying information (Cell ID), Global Positioning System coordinates, and status codes, etc.

In some embodiments, a communication module may transmit user data comprising status information. The status information may be coded in at least one digit(s) and/or character(s). For instance, “001” may indicate a particular status and “002” may indicate another status. Any format for the user data may be used as long as the format is suitable for a data field of a session setup message.

An application 106 running on the processor may be configured to process the user data and provide the user data in a data field of a session setup message. The application may be a software application. In some embodiments, the application may be a light-weight software application configured to run on an operating system of the device. In some embodiments, at least part of the application may be implemented as hardware.

The application provides the user data in a data field of a session setup message. The communication module may be triggered to transmit a session setup message during normal operation of the communication module (e.g., during a regular session setup process demanded by the communication module), and/or the communication module may be triggered to transmit a session setup message when the communication module is required to transmit user data to the data processing center in accordance with a schedule and/or when the user data has changed (thus requiring the user data to be updated at the data processing center).

The content in the data field of the session setup message is adapted to be transmitted from one telecommunications network (e.g., network A) to another telecommunications network (network B). The data field may be required to be transmitted, e.g., without modification, filtering, or removal, from a visited telecommunication network to a home telecommunications network. For instance, a valid access point name may be provided in an access point name field (shown as illustrative message 136). This characteristic of the data field ensures that the user data is provided to the home telecommunications network without fail and/or with substantial certainty. For instance, the data field for an access point name (APN) in a Packet Data Protocol (PDP) context setup message may be used, because the content in the APN data field is adapted to be transmitted and/or forwarded to the home telecommunications network.

The application may provide the user data in the data field of the session setup message in different ways. In some embodiments, the user data is appended to other (valid) data in the data field of the session setup message (shown as illustrative message 138). Advantageously, the user data is piggybacked to other data in the data field. Accordingly, the other data in the data field may still be used for the session setup message. In other words, a session may still be successfully setup through the other (valid) data provided in the data field (if such a technical result is desired). In some embodiments, the user data is provided (e.g., replacing otherwise valid data) in the data field of the session setup message (e.g., rather than appending the user data to valid data) (shown as illustrative message 140). Accordingly, the user data is not adapted to be used for successfully setting up the session setup message.

Once the user data has been provided in the data field of the session setup message, the message may be transmitted by the transmitter of the communication module to a receiving station (e.g., a base station) of network A. The message may be transmitted to a support node 116 configured to process the session setup message. The support node may be a Serving GPRS Support Node (SGSN), which is a component for handling packet switched data within a GPRS (General Packet Radio Service) network.

The support node 116, e.g., required by the telecommunications standard of the session setup message, transmits the content provided in the data field of the session setup message (said content having the user data) to a processing part 120 on network B through a backbone 118. For instance, the telecommunications standard may require the data in the data field to be provided to network B without modification, filtering, and/or removal when a communication module transmits the session setup message to the support node 116. For instance, the support node may transmit a requested APN in an APN data field of the session setup message to network B. The backbone may be an network, which is configured to interconnect various support node(s) or processing part(s) belonging to different telecommunication networks having different operators. In some embodiments, the backbone is a global GPRS roaming network comprising at least one a GPRS roaming eXchange (GRX) nodes, which provides the connectivity between networks.

In some embodiments, the user data is provided in the Access Point Name (APN) data field. Typically, the APN data field transports a character string (i.e., a requested APN) that may include identifier(s) or name(s) referring to the access point within a telecommunications network (e.g., an access point 130 of support node 128). The support node 128 may be a Gateway GPRS Support Node (GGSN), which is a component for interworking between the GPRS (General Packet Radio Service) network and external packet switched networks such as the Internet, an intranet, or other suitable packet switched networks.

In some embodiment, the requested APN may include an identifier of an operator of a telecommunications network (e.g., operator of network B). Typically, a telecommunications network may have a plurality of access points (e.g., access point 130 of support node 128), to which allows a communication module to access an external network 132 (e.g., the Internet or an Intranet). Accordingly, the content in the data field enables a communication module to specify the access point by its name. Advantageously, the ability by the communication module to specify (freely) the access point name allows other data (i.e., user data) to be put in place of or in addition to an access point name (i.e., valid data).

The access point name may map to an address of a support node 128 (e.g., Gateway GPRS support node) configured to provide a communication module with access to an external network through access point 130. The support node 116 is generally required to transmit the requested APN to the home network (network B) for resolution. This may be due to the nature that individual telecommunication operators do not maintain the addresses of all the access points in association with the respective access point names (this would be technically impractical). Thus, to resolve the access point name (i.e., the requested APN) given in the access point name data field of a session setup message, network A is adapted to transmit the requested APN (which includes the user data) to network B (i.e., by default, without modification, filtering, or removal).

For instance, the support node 116 may provide the user data from network A to network B through the backbone as part of a resolve request. The resolve request is configured to request a processing part 120 (e.g., a Domain Name System (DNS) server) in network B to resolve an access point name (i.e., the requested APN) to an address of an access point to the Internet or an intranet. The resolve request may include the requested APN and identifying information of the communication module which transmitted the session setup message.

As a result, network B is configured to receive and/or capture the user data from the data field of a session setup message that was transmitted by the communication module, because the user data is transmitted to network B through the resolve request. The processing part 120 may then extract the user data received (e.g., by processing the resolve request), and provide the (extracted) user data to the data processing center 124. The user data may be stored in storage 126. The data processing center may store any extracted user data, a timestamp, and/or identifying information of the communication module (e.g., Mobile Station International Subscriber Directory Number (MSIDSN) and International Mobile Subscriber Identity (IMSI)). In some embodiments, the processing part 120 and/or the data processing center 124 may simply record the requested APN (without extracting the user data) and the user data may be extracted at a later time.

The processing part 120 may be configured with a list of access point name(s) in association with address(es) of the support node(s) configured to provide access to an access point of an external network (e.g., as a Domain Name System server). Accordingly, an access point name having a corresponding address may be considered as a valid access point name. In conventional operations, a valid access point name is provided in the access point name field of a session set up message (shown as message 136).

If the user data is provided in the access point name data field, the requested APN in the resolve request would not resolve to an address of an access point. Thus, the requested APN would be considered an invalid access point name. If the processing part determines that the requested APN is invalid, the processing part may then extract any user data in the invalid APN.

In some embodiments, the application of the communication module may provide only the user data in the APN data field (shown as illustrative message 140). Then the processing part, upon determining that the requested APN is invalid, provides the requested APN to the data processing center.

In some embodiments, the application of the communication module may provide the user data together with a valid access point name using a particular syntax (shown as illustrative message 138). For instance, the user data may be appended before and/or after a valid access point name. The processing part may be configured to process the requested APN to detect whether the particular syntax is used and extract the user data from the requested APN (each time a resolve request is received and/or upon determining that the requested APN is invalid). Likewise, the valid access point may be determined from the requested APN and said valid access point may have an associated address. The associated address may then be returned from the processing part. Then, the communication module may setup a session using the associated address (e.g., address of the support node 128 having the access point 130 to the external network 132).

If a valid access point name was provided in the data field of the data field (e.g., appended with the user data), a session may be setup and a call detail record may be generated in a call detail record server of 134. As a result, the communication module may be charged for setting up a session.

If the user data was provided in the data field (e.g., without appending the user data with a valid APN) and thus an invalid access point name was provided to processing part 120, then a session reject message may be transmitted from network B to network A (rejecting a session to be setup and/or indicating that the session setup message has failed). As a result a call detail record may not be generated or may be removed if it was generated such that the communication module is not charged for setting up a session. Advantageously, the user data is provided to network B without cost. Furthermore, the user data may be advantageously transported during a session setup process without using up significant network resources to actually setup a session (which may be hugely significant in aggregate of many communication modules). The user data being transported during the session setup process rather than in the payload of messages transmitted during a session may protect privacy because the forwarding of user data through the setup process avoids having to inspect the payload and extracting the user data from the payload of messages transmitted during a session. If the user data is transported during a session, the system would be required to inspect the payload to extract user data.

In some embodiments, a monitor may be provided in network B to sniff/detect resolve request messages or other suitable messages being transmitted from network A to network B. The monitor may be implemented similarly to processing part 120. For instance, the monitor may be configured to extract user data in the resolve request sniffed from the network, and provide that user data in a similar manner to the data processing center. In these embodiments, the DNS resolution may be processed by a DNS server without reconfiguring the DNS server to extract the user data.

One skilled in the art may appreciate that the monitor, the processing part 120 and/or data processing center 124 may be implemented together within a single entity or across in a plurality of entities.

Although an APN data field is described herein, one skilled in the art would appreciate that other data fields may be suitable, as long as the data field is adapted to be transmitted to the home network without modification, filtering, or removal. Such a characteristic enables the user data to be relayed to network B as part of the required processing of the session setup message (or other suitable messages). For instance, the proxy data field may be used to transport user data, which may be configured to be transmitted to the home network (e.g., to be resolved by a DNS server on the home network).

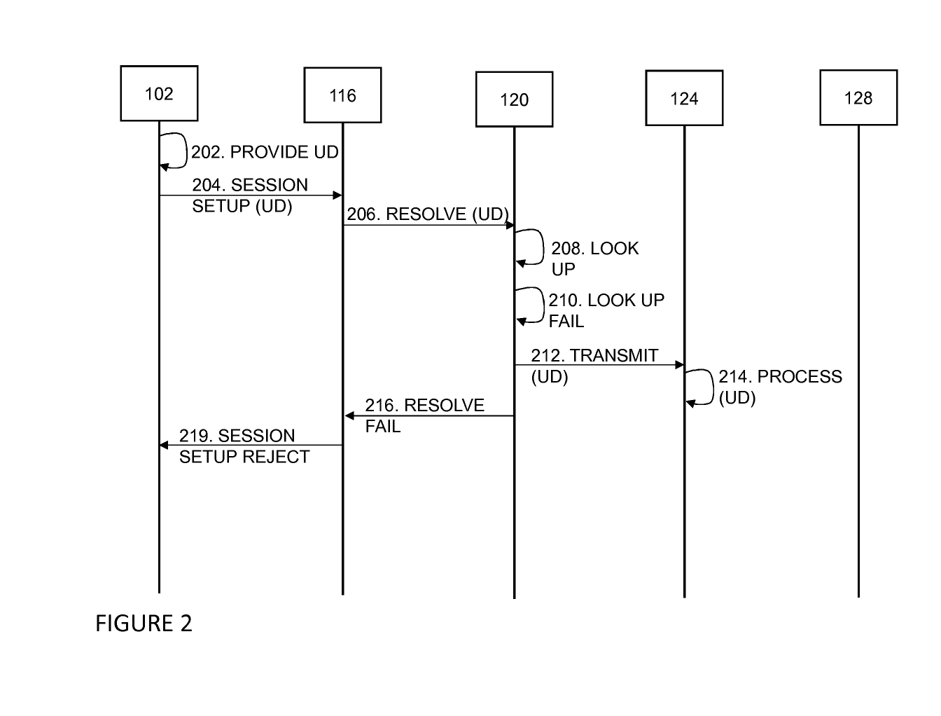

FIG. 2 shows an exemplary messaging diagram, according to an embodiment of the disclosure. A communication module 102, e.g., through the use of a sensor, may be configured with an application to provide user data in a session setup message (step 202). The user data may be provided in a data field used by a session setup message (e.g., an APN data field). For instance, the user data may be provided in place of and/or rather than using a normal/valid data for the particular data field, e.g., a valid APN name. The session setup message is transmitted through a first telecommunications network from the communication module 102 to a support node 116 (step 204). The support node may be configured to process session setup messages originating from communication modules communicably connected to the first network.

The data field in which the user data is provided is adapted to be transmitted to a second telecommunications network. The user data may be transmitted through a resolve request (step 206) to a processing part 120. The data field of the session setup message has the characteristic that the content in the data field (e.g., a requested APN) is transmitted to the second network by default, due to requirements of the session setup message and/or the standard used by the session setup message.

The processing part, in response to receiving the resolve request, may attempt to process the resolve request by looking up whether, e.g., the requested APN is one of the valid APNs (step 208). If the user data is provided in the requested APN, the processing part would accordingly determine that the lookup has failed (step 210). The user data may be extracted from the requested APN and may be transmitted to a data processing center 124 (step 212). The data processing center may record the user data (step 214) for further processing (e.g., data recordation or analysis).

The processing part, in response to a failure to look up the user data, may transmit a resolve failed message to support node 116, which may in turn transmit a session setup rejection/failure message to communication module 102. As a result a session is not setup. Advantageously, the user data is transmitted (without fail) to the data processing center without cost (e.g., without creating a Call Detail Record).

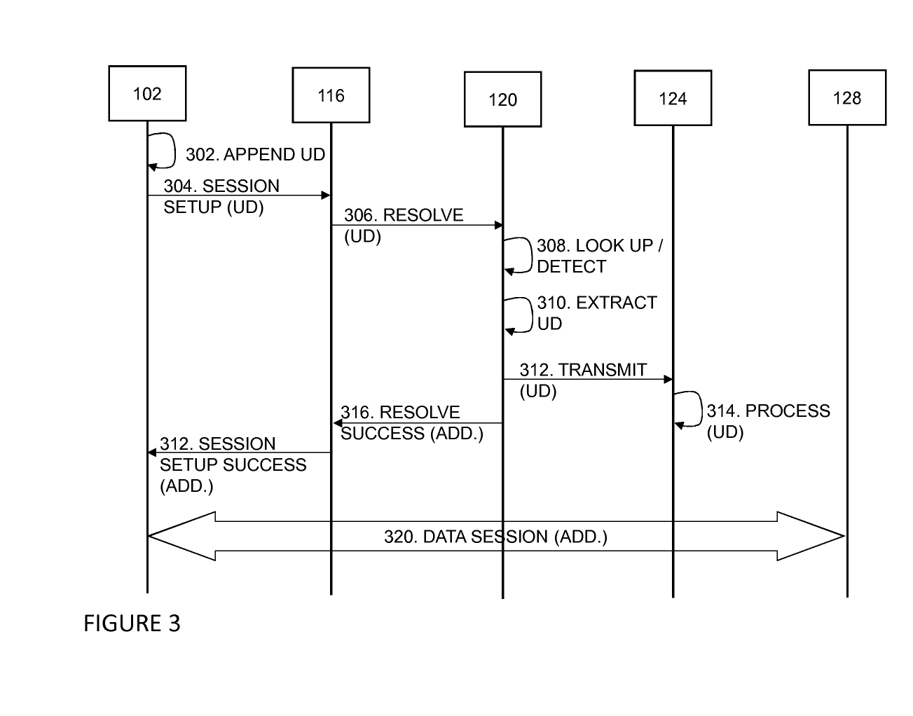

FIG. 3 shows another exemplary messaging diagram, according to an embodiment of the disclosure. A communication module may append the user data to other (valid/normal) data (step 302) when transmitting a session setup message to support node 116 (step 304). For instance, the user data may be appended before and/or after the other data using a particular syntax (e.g., “001.Internet”, “Internet/001”). Advantageously, the user data is piggybacked with valid data, and is transmitted (without fail) to the home network.

The session setup message is transmitted through a first telecommunications network from the communication module 102 to a support node 116 (step 304). The support node may be configured to process session setup messages originating from communication modules communicably connected to the first network.

The data field in which the user data is provided is adapted to be transmitted to a second telecommunications network. The user data along with the other data may be transmitted through a resolve request (step 306) to a processing part 120. The data field of the session setup message has the characteristic that the content in the data field (e.g., a requested APN) is transmitted to the second network by default, due to requirements of the session setup message and/or the standard used by the session setup message.

The processing part, in response to receiving the resolve request, may attempt to process the resolve request by looking up whether, e.g., the requested APN is one of the valid APNs (step 308). Because the user data is provided together with the other data, the processing part would accordingly determine that the lookup has failed since the user data along with the other data (e.g., a valid access point name) does not match with one of the valid access point names. In response to determining that lookup has failed, the user data may be extracted from the requested APN (e.g., in accordance with a predetermined syntax) (step 310) and the user data may be transmitted to a data processing center 124 (step 312).

In some embodiments, the user data along with the other data may be forwarded to data processing center 124 and the data processing center may be configured to extract the user data (step 314) from the requested APN. The data processing center may record the user data (step 314) for further processing (e.g., data recordation or analysis).

In some embodiments, the processing part, in response to receiving the resolve request may detect that the particular syntax is used and thus determine that the user data is present in the requested APN (prior to performing a look up operation (step 308)). Upon detecting that the user data is present, the user data may then be extracted from the requested APN (step 310). The other data (i.e., having a valid access point name) may also be extracted in a similar fashion as how the user data is extracted from the requested APN. The data processing part may perform a look up operation to determine whether the other data comprises a valid access point name. If the other data can be resolved to an address for a support node having the access point to the external network, a resolve success message may be transmitted to support node 116 indicating that the resolve request has been successful (step 316). The resolve success message may include the address of the support node 128 having the access point. Advantageously, the user data is piggybacked to a valid access point (or other suitable valid data) during a regular session setup session. The user data is thus conveniently transmitted to the home network whenever a session is to be setup between the communication module and the external network.

A session setup successful message 318 indicating that a session may be setup using the address resolved by the processing part 124 may be transmitted from support node 116 to communication module 102. As a result, the communication module 102 is able to address support node 128 to access an external network through a data session (step 320).

Although the disclosure generally describes the situation where the embodiments are suitable for use in a plurality of telecommunication networks (visited/roaming and home networks) operated by different telecommunications operators, the disclosed embodiments may be also used in a telecommunications network operated by a single telecommunications operator, and the session setup request would then be handled by a supporting node and a processing part of a home telecommunications network that the communication module is in. Furthermore, although the embodiments are described in relation to a Public Land Mobile Network, the implementation may also be used in other suitable telecommunications networks, irrespective of the technologies used.

A network suitable for the disclosed embodiment preferably enables a communication module using a first telecommunications network to transmit a session setup message to setup a session. The communication module may provide the user data in a data field of said session setup message. The data field that is adapted to be forwarded from the first telecommunications to a second telecommunications network in which a data processing center for processing the user data is located. Such a characteristic of the data field is preferably a requirement by the network technology being used. Suitable networks may include, although not limited to, UMTS (Universal Mobile Telecommunications System), LTE (Long Term Evolution), WiMax (Worldwide Interoperability for Microwave Access), WiFi, CDMA (Code Division Multiple Access), GSM (Global System for Mobile Communications), GPRS (General Packet Radio Service), EDGE (Enhanced Data Rates for GSM Evolution) technologies, etc.

A type or types of network technology may be suitable as long as the communication modules on one network are enabled to transmit session setup messages to set up a session between the communication module and an access point in another network. The data field to be used may be the access point name field in the session setup message, which is to be processed by a processing part of the other network.

FIGS. 2 and 3 are described in terms of steps to be performed, but it is not to be construed that the steps described must be performed in the exact order described and/or one after another. One skilled in the art may envision to change the order of the steps and/or to perform steps in parallel to achieve equivalent technical results.

With some modifications, one skilled in the art may extend the embodiments described herein to other architectures, networks, or technologies.

Various embodiments of the invention may be implemented as a program product for use with a computer system or a processor, where the program(s) of the program product define functions of the embodiments (including the methods described herein). In one embodiment, the program(s) can be contained on a variety of non-transitory computer-readable storage media (generally referred to as “storage”), where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

1. A method for transmitting user data from a communication module communicably connected to a first telecommunications network to a second telecommunications network, said user data being provided to a data processing center in the second telecommunications network, the method comprising:
providing the user data in a data field of a session setup message;
transmitting said session setup message having the user data from the communication module to the first network;
wherein the user data is in the data field adapted to be forwarded from the first telecommunications network to the second telecommunications network.

2. A method for transmitting user data from a communication module communicably connected to a first telecommunications network to a second telecommunications network, said user data being provided to a data processing center in the second telecommunications network, the method comprising:
receiving the user data in a data field of a session setup message transmitted from the communication module; and
transmitting the user data from the first network to the second network, wherein the user data is in the data field adapted to be forwarded from the first telecommunications network to the second telecommunications network.

3. A method for processing user data from a communication module, said user data transmitted from the communication module communicably connected to a first telecommunications network to a second telecommunications network, the method comprising:
receiving the user data from a data field of a session setup message, said session setup message being transmitted from the communication module to the first telecommunications network; and
wherein the user data is in the data field adapted to be forwarded from the first telecommunications network to the second telecommunications network.

4. The method according to claim 1, wherein the first telecommunications network is operated by a visited operator of the communication module and the second telecommunications network is operated by a home operator of the communication module.

5. The method according to claim 1, wherein the session setup message is a Packet Data Protocol (PDP) context setup message.

6. The method according to claim 1, wherein the data field is an access point name field, and the user data is appended to or replaces a valid access point name.

7. The method according to claim 3, further comprising:
extracting the user data from a request having the user data in a processing part of the second telecommunications network, said processing part being configured to process requests associated with the data field; and
providing the extracted user data to the data processing center.

8. The method according to claim 7, wherein:
the processing part of the second telecommunications network is a domain name system server configured to resolve an access point name to an address of an access point to the Internet or an intranet.

9. The method according to claim 3, further comprising:
receiving a request associated with the data field, said request comprising user data provided in the data field of the session setup message which was transmitted by the communication module;
determining whether the request includes an invalid access point name, said invalid access point name not being one of the valid access point name(s) which resolves to an address of an access point to the Internet or an intranet.

10. The method according to claim 9, further comprising:
when the request includes an invalid access point name, extracting the invalid access point name from the request and providing the invalid access point name to the data processing center.

11. The method according to claim 2, further comprising:
transmitting a session reject message from the first telecommunications network to the communication module, said message rejecting a session to be setup between the communication module and an access point.

12. The method of claim 1, wherein the user data comprises status information and/or location information.

13. A telecommunications network configured to:
receive user data in a data field of a session setup message transmitted from a communication module; and
transmit the user data to a second telecommunications network, wherein the user data is in the data field adapted to be forwarded from the telecommunications network to the second telecommunications network.

14. (canceled)

15. (canceled)

16. A computer program product, implemented on computer-readable non-transitory storage medium, the computer program product configured, when run on a computer, to cause the computer to:
provide user data in a data field of a session setup message; and
transmit said session setup message having the user data from the computer to a first network,
wherein the user data is in the data field adapted to be forwarded from the first telecommunications network to a data processing center in a second telecommunications network.

17. The method according to claim 2, wherein the first telecommunications network is operated by a visited operator of the communication module and the second telecommunications network is operated by a home operator of the communication module.

18. The method according to claim 2, wherein the session setup message is a Packet Data Protocol (PDP) context setup message.

19. The method according to claim 2, wherein the data field is an access point name field, and the user data is appended to or replaces a valid access point name.

20. The method according to claim 2, wherein the user data comprises status information and/or location information.

21. The method according to claim 3, wherein the first telecommunications network is operated by a visited operator of the communication module and the second telecommunications network is operated by a home operator of the communication module.

22. The method according to claim 3, wherein the session setup message is a Packet Data Protocol (PDP) context setup message.

23. The method according to claim 3, wherein the data field is an access point name field, and the user data is appended to or replaces a valid access point name.

24. The method according to claim 3, wherein the user data comprises status information and/or location information.
